(19) United States
(12) Patent Application Publication
(10) Pub. No.: US 2026/0366891 A1
(43) Pub. Date: Nov. 19, 2026

(54) ELECTRICAL CONNECTION ASSEMBLY AND CONTACT DETECTION SENSOR PAD USING THE SAME

(71) Applicants: KOMOS CO., LTD., Hwaseong-si Gyeonggi-do (KR); DGK, Hanam-si Gyeonggi-do (KR)

(72) Inventors: In Chul YOO, Hwaseong-si Gyeonggi-do (KR); Hyeoung Seok SONG, Suwon-si Gyeonggi-do (KR); Seok Hwan JI, Suwon-si Gyeonggi-do (KR); Dae Jin KO, Hanam-si Gyeonggi-do (KR)

(73) Assignees: KOMOS CO., LTD., Hwaseong-si Gyeonggi-do (KR); DGK, Hanam-si Gyeonggi-do (KR)

(21) Appl. No.: 19/402,068

(22) Filed: Nov. 26, 2025

(30) Foreign Application Priority Data
May 15, 2025 (KR) 10-2025-0062993

(51) Int. Cl. G01D 5/241; H01R 4/58

(52) U.S. Cl. CPC G01D 5/241; H01R 4/58

(57) ABSTRACT

Provided are an electrical connection assembly and a contact detection sensor pad using the same. An electrical connection assembly with respect to a conductive fabric includes a connector formed of a conductive material and electrically connected to a conductive region of the fabric, and a fixing member covering an upper portion of the connector, adhered to the fabric, and fixing the connector to the fabric.

### CROSS-REFERENCE TO RELATED APPLICATIONS

This application claims priority to Korean Patent Application No. 10-2025-0062993 filed on May 15, 2025, the entire contents of which are herein incorporated by reference.

### BACKGROUND

### 1. Field

The disclosure relates to an electrical connection assembly and a contact detection sensor pad using the same. More particularly, the disclosure relates to an electrical connection assembly that electrically connects a conductive fabric to a cable and a capacitive contact detection sensor pad with the electrically connected conductive fabric applied using the electrical connection assembly.

### 2. Description of the Related Art

Recently, in the automobile industry, various technologies have been applied to improve the safety and convenience of drivers. Among these, technology for detecting whether drivers are gripping steering wheels by using capacitive contact detection sensors mounted on the steering wheels is being adopted. Such grip detection technology may prevent driver distraction or drowsy driving, and provide safer driving environments through linkage with autonomous driving systems.

In the conventional capacitive contact detection sensor, electrodes forming capacitance were formed as metal plates. Soldering was used when electrically connecting cables to these metal plates. However, the electrodes in the form of metal plates are not easily mounted on curved surfaces of steering wheels due to their low flexibility. In addition, the electrodes in the form of metal plates were uncomfortable due to discomfort when drivers grip the steering wheels.

To solve this problem, technology for replacing electrodes in the form of metal plates with conductive fabrics has been developed, but there is a problem in that an electrical connection of the conventional soldering method to conductive fabrics causes damage to the fabrics.

### SUMMARY

Provided are an electrical connection assembly that may form a stable and accurate electrical connection without damaging a conductive fabric in a process of being electrically connected to the conductive fabric, and a contact detection sensor pad using the same that may be mounted naturally on a curved shape of a steering wheel by using a stretchable and flexible conductive fabric as an electrode.

The solutions of the disclosure are not limited to the above-mentioned contents, and other technical problems not mentioned will be clearly understood by one of ordinary skill in the art from the following description.

According to an embodiment of the disclosure, an electrical connection assembly with respect to a conductive fabric includes a connector formed of a conductive material and electrically connected to a conductive region of the fabric, and a fixing member covering an upper portion of the connector, adhered to the fabric, and fixing the connector to the fabric.

The connector, as a metal plate, may have one surface contacting the conductive region, and include a connection unit connected to a conductor of a cable.

The connection unit may include an insertion hole into which the cable is inserted and compressed, and be provided on the other surface of the connector.

A plurality of connection units may be formed in the connector, and aligned side by side so that the cable is inserted in a straight line and compressed.

The fixing member may include a pair of a first fixing member and a second fixing member, the first fixing member may cover the upper portion of the connector and be attached to an upper surface of the fabric with an adhesive, the second fixing member may be attached to a lower surface of the fabric with an adhesive, and the adhesive of the first fixing member and the adhesive of the second fixing member may penetrate into a gap between yarns of the fabric and adhere to each other.

A plurality of protruding pins may be respectively provided on one surface of the first fixing member and one surface of the second fixing member, and penetrate into the gap between the yarns of the fabric.

The protruding pin of the first fixing member and the protruding pin of the second fixing member may be provided at positions that do not overlap each other.

According to another embodiment of the disclosure, a capacitive contact detection sensor pad includes a first fabric layer and a second fabric layer each including a conductive region, and a non-conductive dielectric layer provided between the first fabric layer and the second fabric layer, wherein the conductive region of the first fabric layer and the conductive region of the second fabric layer are electrically connected to different cables through an electrical connection assembly, and the electrical connection assembly includes a connector formed of a conductive material and electrically connected to the conductive region, and a fixing member covering an upper portion of the connector, adhered to the first fabric layer or the second fabric layer, and fixing the connector to the first fabric layer or the second fabric layer.

The connector, as a metal plate, may have one surface contacting the conductive region, and include a connection unit connected to a conductor of a cable.

The connection unit may include an insertion hole into which the cable is inserted and compressed, and be provided on the other surface of the connector.

A plurality of connection units may be formed in the connector, and aligned side by side so that the cable is inserted in a straight line and compressed.

The fixing member may include a pair of a first fixing member and a second fixing member, the first fixing member may cover the upper portion of the connector and be attached to an upper surface of the fabric with an adhesive, the second fixing member may be attached to a lower surface of the fabric with an adhesive, and the adhesive of the first fixing member and the adhesive of the second fixing member may penetrate into a gap between yarns of the fabric and adhere to each other.

A plurality of protruding pins may be respectively provided on one surface of the first fixing member and one surface of the second fixing member, and penetrate into the gap between the yarns of the fabric.

The protruding pin of the first fixing member and the protruding pin of the second fixing member may be provided at positions that do not overlap each other.

### BRIEF DESCRIPTION OF THE DRAWINGS

FIG. 1 is a diagram illustrating a connector of an electrical connection assembly and a cable being connected to each other according to an embodiment of the disclosure;

FIG. 2 is a diagram illustrating an electrical connection assembly and a fabric being connected to each other according to an embodiment of the disclosure;

FIG. 3 is a diagram illustrating a conductive region that is woven by including a conductive yarn according to an embodiment of the disclosure;

FIG. 4 is a cross-sectional view illustrating a fixing member adhered to a fabric according to an embodiment of the disclosure;

FIGS. 5A and 5B are diagrams illustrating an electrical connection assembly of the disclosure fixed to a fabric;

FIG. 6 is a diagram illustrating a fixing member on which a protruding pin is formed according to an embodiment of the disclosure;

FIG. 7 is a diagram illustrating a structure of a contact detection sensor pad according to an embodiment of the disclosure; and

FIG. 8 is a diagram illustrating a contact detection sensor pad connected to a cable by an electrical connection assembly and mounted on a steering wheel.

### DETAILED DESCRIPTION

The disclosure will now be described more fully with reference to the accompanying drawings, in which embodiments of the disclosure are shown. These embodiments are provided so that the disclosure will be thorough and complete, and will fully convey the concept of the disclosure to those of skill in the art. The disclosure may, however, be embodied in many different forms and should not be construed as being limited to the embodiments set forth herein. For clarity, portions that are not relevant to the description of the present disclosure are omitted.

The terms used in the present specification are merely used to describe particular embodiments of the disclosure, and are not intended to limit the disclosure. An expression used in the singular encompasses the expression of the plural, unless it has a clearly different meaning in the context.

In the present specification, it is to be understood that the terms such as “including”, “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

In addition, the components shown in the embodiments of the disclosure are shown independently to represent different characteristic functions, and do not mean that each component includes separate hardware or one software unit. That is, each component is described by listing each component for convenience of description, and at least two of the components may be combined to form one component, or one component may be divided into a plurality of components to perform a function. The integrated and separated embodiments of each of these components are also included within the scope of the disclosure without departing from the spirit of the disclosure.

In addition, embodiments below are provided so that the present disclosure will be thorough and complete, and will fully convey the concept of the disclosure to those skilled in the art. In the drawings, sizes and thicknesses of components may be exaggerated for clarity.

Hereinafter, the disclosure will be described in detail with reference to the attached drawings.

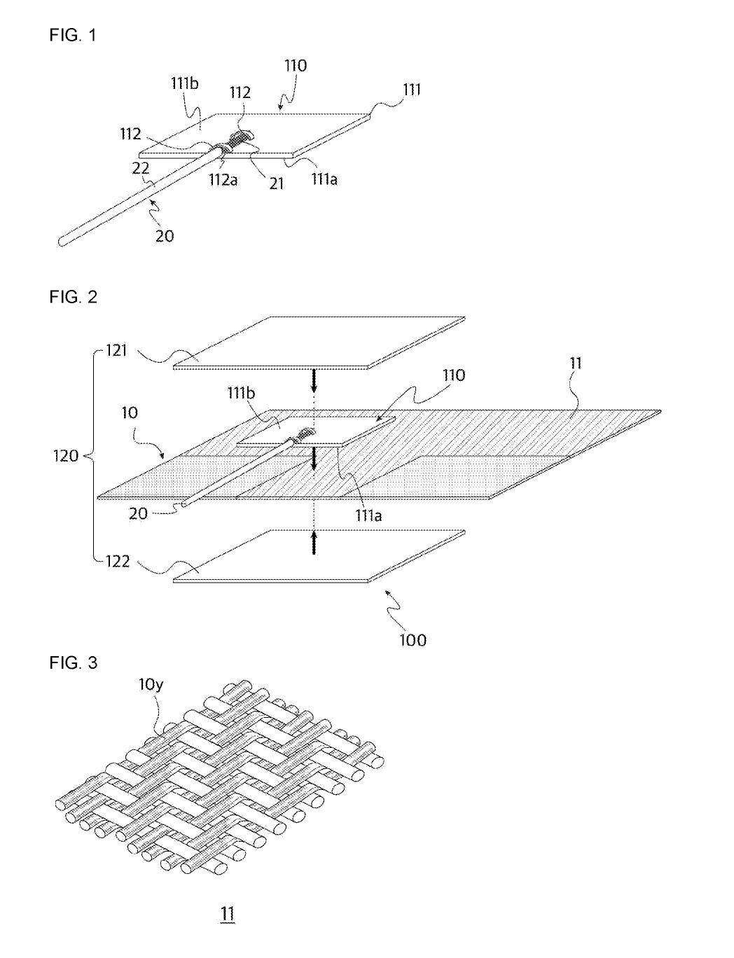

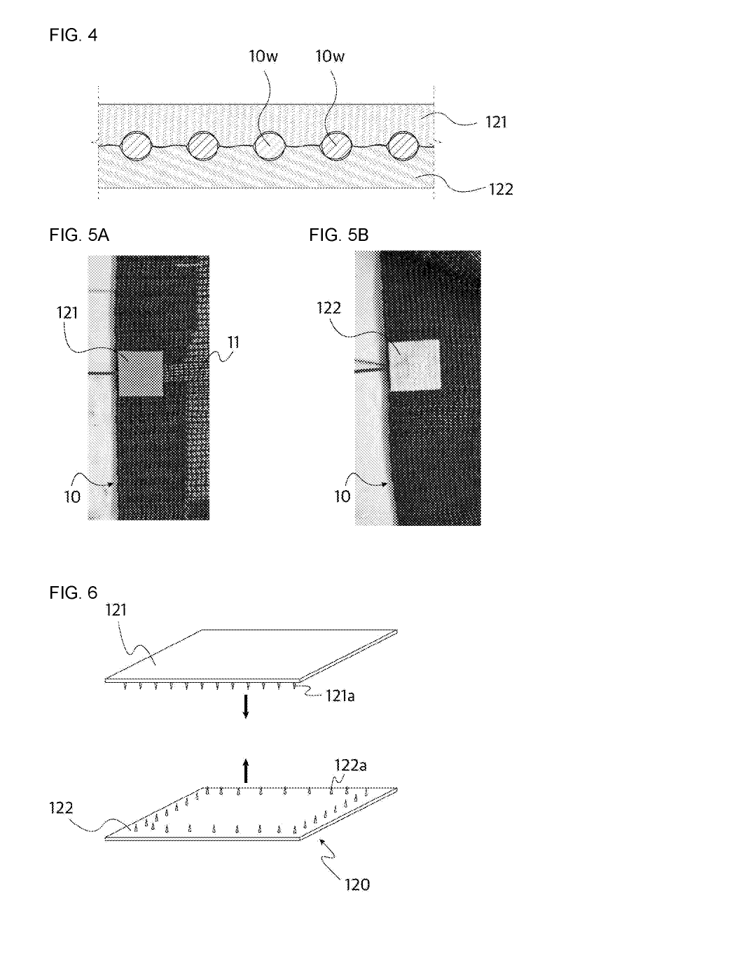

FIG. 1 is a diagram illustrating a connector of an electrical connection assembly and a cable being connected to each other according to an embodiment of the disclosure. FIG. 2 is a diagram illustrating the electrical connection assembly and a fabric being connected to each other according to an embodiment of the disclosure. FIG. 3 is a diagram illustrating a conductive region that is woven by including a conductive yarn according to an embodiment of the disclosure. FIG. 4 is a cross-sectional view illustrating a fixing member adhered to a fabric according to an embodiment of the disclosure. FIGS. 5A and 5B are diagrams illustrating the electrical connection assembly of the disclosure fixed to the fabric.

Referring to FIGS. 1-5, an electrical connection assembly 100 according to an embodiment of the disclosure is for electrically connecting a conductive fabric 10 to a cable 20, and may include a connector 110 and a fixing member 120.

The connector 110 is for electrically connecting a conductive region 11 formed on the fabric 10 to the cable 20, and may be formed of a conductive material. The conductive region 11 may be a region that is woven by including a conductive yarn 10y as shown in FIG. 3.

The connector 110 may include a plate 111 that contacts the conductive region 11 of the fabric 10 and forms an electrical connection to the fabric 10 and a connection unit 112 that contacts a conductor 21 of the cable 20 and forms an electrical connection to the cable 20. The plate 111 may be formed of a metal of a conductive material to have conductivity. The plate 111 may have an area and thickness capable of electrical connection to the conductive region 11 of the fabric 10, but the area and thickness may be minimized. One surface 111a of the plate 111 may be seated in the conductive region 11 of the fabric 10 and contact a plurality of conductive yarns 10y, thereby forming an electrical connection to the fabric 10. The connection unit 112 may be formed on the other surface 111b of the plate 111. The connection unit 112 may be formed in various shapes according to embodiments. In the present embodiment, the connection unit 112 may be provided in a protruding structure extending from the other surface 111b of the plate 111 and including an insertion hole 112a. The conductor 21 of the cable 20 may be inserted into the insertion hole 112a of the connection unit 112. The connection unit 112 may be compressed while the cable 20 is inserted into the insertion hole 112a so that the conductor 21 of the cable 20 is in close contact with the other surface 111b of the plate 111 and an inner surface of the connection unit 112, thereby forming an electrical connection to the connector 110 and the cable 20. At this time, an outer sheath 22 of the cable 20 may be also compressed, and thus, the reliability of a connection part may be secured.

In an embodiment, a plurality of connection units 112 may be formed, but aligned side by side so that the cable 20 is inserted in a straight line and compressed. The cable 20 may be inserted into the insertion hole 112a formed in each of the connection units 112. At this time, the connection units 112 may be located side by side so that the insertion holes 112a may be aligned in order for the cable 20 to be inserted in a straight line. The electrical connection between the connection unit 112 and the cable 20 may be formed in a multiple structure, and thus, even though the electrical connection of one connection unit 112 is temporarily weakened by vibration or external impact, a connection of the other connection unit 112 exists, and thus, the overall electrical connection to the cable 20 may be maintained stably. In addition, a physical connection to the cable 20 may be more robust, which may reduce the probability of separation of the cable 20 and contact degradation.

The fixing member 120 is for fixing the connector 110 to the fabric 10, and may be provided as a pair of first fixing member 121 and second fixing member 122. The first fixing member 121 and the second fixing member 122 are adhesive pads having adhesive materials, and cover both sides of the fabric 10 on which the connector 110 is seated together with the connector 110, thereby fixing the connector 110 to the fabric 10.

Specifically, the first fixing member 121 may be attached to an upper surface of the fabric 10 to cover an upper part of the plate 111 of the connector 110, and the second fixing member 122 may be attached to a lower surface of the fabric 10. The first fixing member 121 and the second fixing member 122 may be formed to be larger than the area of the plate 111 of the connector 110 so that the first fixing member 121 may extend beyond the plate 111 and be broadly attached over the fabric 10 that is the periphery of the plate 111. The second fixing member 122 may also be attached to the fabric 10 on the lower surface of the fabric 10 to correspond to the first fixing member 121. At this time, as shown in FIG. 4, the first fixing member 121 attached to the fabric 10 and the second fixing member 122 at the corresponding position may penetrate gaps of yarns 10w forming the fabric 10 and adhere to each other, thereby providing a more robust coupling force than simply attaching to the surface of the fabric 10. Here, the yarns 10w may include both a conductive yarn and a non-conductive yarn. FIG. 5A is a photograph showing the first fixing member 121 attached to the fabric 10, and FIG. 5B is a photograph showing the second fixing member 122 attached to the fabric 10. As shown in FIGS. 5A and 5B, the first fixing member 121 and the second fixing member 122 may cover both sides of the fabric 10 together with the connector 110 to fix the connector 110 to the fabric 10.

FIG. 6 is a diagram illustrating a fixing member on which a protruding pin is formed according to an embodiment of the disclosure.

Referring to FIGS. 2 and 6, in an embodiment, a plurality of protruding pins 121a and 122a may be respectively provided on one surface of the first fixing member 121 and the second fixing member 122 so that the fixing member 120 may reliably support the fabric 10 and stably couple the connector 110 to the fabric 10. Each of the protruding pins 121a and 122a is for stably supporting and fixing the fabric 10 by penetrating into a gap between the yarns 10w of the fabric 10 when the first fixing member 121 and the second fixing member 122 are attached to the fabric 10, and may be respectively provided at edges of the first fixing member 121 and the second fixing member 122 to escape the plate 111 and penetrate the fabric 10 around the plate 111. At this time, the protruding pin 121a of the first fixing member 121 and the protruding pin 122a of the second fixing member 122 may be provided at positions that do not overlap each other. That is, paths through which both pins penetrate through the fabric 10 are disposed so as not to collide or interfere with each other, and thus, the fixing members 120 may be elaborately engaged with each other.

The protruding pins 121a and 122a provided in the fixing member 120 may penetrate the gap between the yarns 10w so that the fixing member 120 may further increase a physical coupling force. In addition, the protruding pins 121a and 122a may be disposed so as not to overlap each other, which may prevent a problem of the protruding pins 121a and 122a colliding or being misaligned in the process of penetrating the fabric 10.

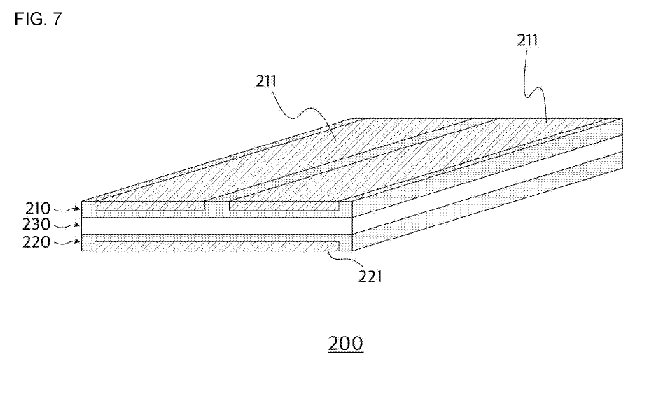

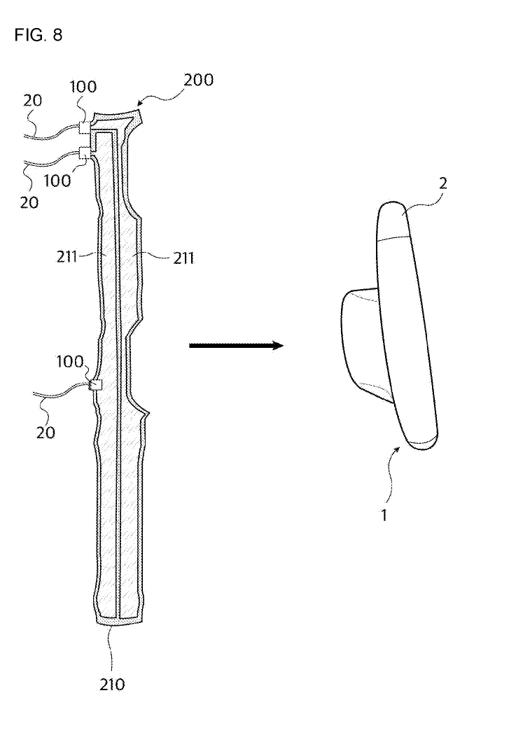

FIG. 7 is a diagram illustrating a structure of a contact detection sensor pad according to an embodiment of the disclosure. FIG. 8 is a diagram illustrating the contact detection sensor pad connected to a cable by an electrical connection assembly and mounted on a steering wheel.

Referring to FIGS. 7 and 8, in an embodiment of the disclosure, a contact detection sensor pad 200 to which the electrical connection assembly 100 is applied may be a capacitive contact detection sensor pad. The contact detection sensor pad 200 may include a first fabric layer 210, a second fabric layer 220, and a dielectric layer 230 disposed therebetween. Conductive regions 211 and 221 that are woven by including the conductive yarns 10y may be respectively provided in the first fabric layer 210 and the second fabric layer 220 as shown in FIG. 3. The dielectric layer 230 may form a gap such that the first fabric layer 210 and the second fabric layer 220 are not in direct contact with each other. The dielectric layer 230 may be formed of a material having insulation and flexibility, such as a polyimide film, a synthetic resin film, or a foam.

The electrical connection assemblies 100 of the disclosure may be respectively connected to the conductive regions 211 and 221 of the first fabric layer 210 and the second fabric layer 220 to be connected to the cables 20. When an electrical connection is activated in each of the conductive regions 211 and 221 of the first fabric layer 210 and the second fabric layer 220 through the cable 20, the conductive regions 211 and 221 may serve as electrodes, which may cause an electrical polarization phenomenon. At this time, when the capacitance between the conductive regions 211 and 221 is measured in real time, and changes, it may be determined that there is contact between the conductive regions 211 and 221.

In an embodiment, the contact detection sensor pad 200 of the disclosure may be applied to a sensor that detects a driver’s grip of the steering wheel 1. The sensor to which the contact detection sensor pad 200 is applied may be mounted on the rim 2 to surround the rim 2. When the contact detection sensor pad 200 of the disclosure which is of a fabric type and easily stretchable is applied to the steering wheel 1 formed in a curved shape, the steering wheel 1 may be naturally mounted on the curved shape of the steering wheel 1, and thus, manufacturing ease may be enhanced. In addition, the fabric 10 may be connected to the cable 20 through the electrical connection assembly 100 suitable for the fabric type, and thus, a stable electrical connection may be formed.

The electrical connection assembly of the disclosure and the contact detection sensor pad using the same may form a connection unit so that a conductor of a cable directly is in direct contact with a plate, thereby simply and stably securing an electrical path from the cable to a conductive region of the fabric via the connection unit through the plate. Accordingly, the electrical connection between the conductive fabric and the cable may be robust, resulting in transmission characteristics of low contact resistance and high reliability.

In addition, utilizing the electrical connection assembly of the disclosure enables the use of a highly stretchable and flexible conductive fabric as an electrode, and thus, a sensor pad which is naturally attachable to a curved structure such as a steering wheel may be manufactured.

According to an embodiment of the disclosure, the electrical connection assembly may form a stable and accurate electrical connection without damaging a conductive fabric in a process of being electrically connected to the conductive fabric, and the contact detection sensor pad using the same may be mounted naturally on a curved shape of a steering wheel by using a stretchable and flexible conductive fabric as an electrode.

The effects of the disclosure are not limited to the above-mentioned effects, and other effects not mentioned will be clearly understood by one of ordinary skill in the art from the description provided above.

Although the disclosure has been described with reference to the embodiment shown in the drawings, this is merely exemplary and will be understood by one of ordinary skill in the art that various modifications and equivalent other embodiments are possible. Therefore, the true technical protection scope of the disclosure will be defined by the technical sprit of the appended claims.

What is claimed is:

1. An electrical connection assembly with respect to a conductive fabric, the electrical connection assembly comprising:
a connector formed of a conductive material and electrically connected to a conductive region of the conductive fabric; and
a fixing member covering an upper portion of the connector, adhered to the fabric, and configured to fix the connector to the fabric.

2. The electrical connection assembly of claim 1, wherein the connector, as a metal plate, has one surface contacting the conductive region, and includes a connection unit connected to a conductor of a cable.

3. The electrical connection assembly of claim 2, wherein the connection unit includes an insertion hole into which the cable is inserted and compressed, and is provided on the other surface of the connector.

4. The electrical connection assembly of claim 3, wherein a plurality of connection units are formed in the connector, and aligned side by side so that the cable is inserted in a straight line and compressed.

5. The electrical connection assembly of claim 1, wherein
the fixing member includes a pair of a first fixing member and a second fixing member,
the first fixing member is configured to cover the upper portion of the connector and is attached to an upper surface of the fabric with an adhesive, the second fixing member is attached to a lower surface of the fabric with an adhesive, and the adhesive of the first fixing member and the adhesive of the second fixing member penetrate into a gap between yarns of the fabric and adhere to each other.

6. The electrical connection assembly of claim 5, wherein a plurality of protruding pins are respectively provided on one surface of the first fixing member and one surface of the second fixing member, and penetrate into the gap between the yarns of the fabric.

7. The electrical connection assembly of claim 6, wherein the protruding pin of the first fixing member and the protruding pin of the second fixing member are provided at positions that do not overlap each other.

8. A capacitive contact detection sensor pad comprising:
a first fabric layer and a second fabric layer each comprising a conductive region; and
a non-conductive dielectric layer provided between the first fabric layer and the second fabric layer,
wherein the conductive region of the first fabric layer and the conductive region of the second fabric layer are electrically connected to different cables through an electrical connection assembly, and
the electrical connection assembly comprises
a connector formed of a conductive material and electrically connected to the conductive region; and
a fixing member covering an upper portion of the connector, adhered to the first fabric layer or the second fabric layer, and configured to fix the connector to the first fabric layer or the second fabric layer.

9. The contact detection sensor pad of claim 8, wherein the connector, as a metal plate, has one surface contacting the conductive region, and includes a connection unit connected to a conductor of a cable.

10. The contact detection sensor pad of claim 9, wherein the connection unit includes an insertion hole into which the cable is inserted and compressed, and is provided on the other surface of the connector.

11. The contact detection sensor pad of claim 10, wherein a plurality of connection units are formed in the connector, and aligned side by side so that the cable is inserted in a straight line and compressed.

12. The contact detection sensor pad of claim 8, wherein
the fixing member includes a pair of a first fixing member and a second fixing member, and
the first fixing member is configured to cover the upper portion of the connector and is attached to an upper surface of the fabric with an adhesive, the second fixing member is attached to a lower surface of the fabric with an adhesive, and the adhesive of the first fixing member and the adhesive of the second fixing member penetrate into a gap between yarns of the fabric and adhere to each other.

13. The contact detection sensor pad of claim 12, wherein a plurality of protruding pins are respectively provided on one surface of the first fixing member and one surface of the second fixing member, and penetrate into the gap between the yarns of the fabric.

14. The contact detection sensor pad of claim 13, wherein the protruding pin of the first fixing member and the protruding pin of the second fixing member are provided at positions that do not overlap each other.
